(19) United States
(12) Patent Application Publication
(10) Pub. No.: US 2011/0274569 A1
(43) Pub. Date: Nov. 10, 2011

(54) HERMETIC COMPRESSOR AND MANUFACTURING METHOD THEREOF

(76) Inventors: Keunju LEE, Changwon (KR); Hongseok Seo, Changwon (KR); Jaechan An, Changwon (KR); Jeongmin Han, Changwon (KR)

(21) Appl. No.: 13/100,378

(22) Filed: May 4, 2011

(30) Foreign Application Priority Data
May 6, 2010 (KR) 10-2010-0042623

(51) Int. Cl. F04B 35/04; B23P 15/00

(52) U.S. Cl. 417/410.1; 29/888.02

(57) ABSTRACT

A hermetic compressor is provided. The hermetic compressor may include a hermetic container; a stator shrink fitted and fixed to an inner wall of the hermetic container; a rotor rotatably provided at an inner portion of the stator; a crankshaft combined with the rotor; a compression device combined with the crankshaft that draws in and compresses refrigerant and discharges the refrigerant to an inner space of the hermetic container; a bearing positioned to be separated from the compression device on the crankshaft; and a bearing support shrink fitted and fixed to an inner wall of the hermetic container that supports the bearing. An outer diameter of the stator and an outer diameter of the bearing support may be larger than an inner diameter of the hermetic container.

### CROSS-REFERENCE TO RELATED APPLICATION(S)

This application claims priority under 35 U.S.C. §119 to Korean Application No. 10-2010-0042623 filed on May 6, 2010, whose entire disclosure(s) is/are hereby incorporated by reference.

### BACKGROUND

1. Field

A hermetic compressor is disclosed herein, and more particularly, a hermetic compressor in which bearings are provided at both upper and lower ends of the crank shaft, and a manufacturing method thereof.

2. Background

In general, a hermetic compressor is provided with a drive motor that generates a driving force in an inner space of the hermetic container, and a compressor mechanism operated in combination with the drive motor to compress refrigerant. The hermetic compressor may be classified as, for example, a reciprocating type, a scroll type, or a vibration type. The reciprocating and scroll type are methods that use a rotational force of the drive motor, and the vibration type is a method that uses a reciprocating motion of the drive motor.

The drive motor of the hermetic compressor that uses a rotational force is provided with a crankshaft that transfers the rotational force of the drive motor to the compression device or unit. For instance, the drive motor of the rotary type hermetic compressor (hereinafter, “rotary compressor”) may include a stator fixed to the hermetic container, a rotor inserted into the stator with a predetermined air gap therebetween and rotated by interaction with the stator, and a crankshaft combined with the rotor to transfer a rotational force of the rotor to the compression device. Further, the compression device may include a compression device combined to the crankshaft to draw in, compress, and discharge refrigerant while rotating within a cylinder, and a plurality of bearing members that supports the compression device while at the same time forming a compression space together with the cylinder. The plurality of bearing members may be arranged at a side of the drive motor to support the crankshaft. However, in recent years, a high-performance compressor has been introduced in which bearings are provided at both upper and lower ends of the crankshaft, respectively, to minimize vibration of the compressor.

However, if bearings are provided at both ends of the crankshaft, then a gap between the bearings and the crankshaft must be precisely maintained to minimize friction loss; however, it may be difficult to maintain a gap between the bearings at both ends thereof as a length of the crankshaft increases. Further, for the drive motor, a gap between the stator and the rotor being fixed and provided at the crankshaft may also have an effect on the performance and efficiency of the drive motor. Accordingly, both the gaps between the two bearings located at both ends of the crankshaft and the stator located at an outer circumferential portion of a central portion of the crankshaft must be precisely maintained, thereby causing a complicated manufacturing process and also causing difficulty in assembly.

### BRIEF DESCRIPTION OF THE DRAWINGS

Embodiments will be described in detail with reference to the following drawings in which like reference numerals refer to like elements, and wherein:

FIG. 1 is a cross-sectional view illustrating a hermetic compressor according to an embodiment;

FIG. 2 is a cross-sectional view, taken along the line I-I of FIG. 1;

FIG. 3 is an exploded cross-sectional view of the hermetic compressor of FIG. 1;

FIG. 4 is a graph illustrating a deformation amount of the bearing support according to a value of I/L in the hermetic compressor of FIG. 1; and

FIG. 5 is a state diagram illustrating part of the process of assembling the hermetic compressor of FIG. 1.

### DETAILED DESCRIPTION

Hereinafter, a hermetic compressor according to embodiments will be described in detail with reference to an embodiment of a rotary compressor illustrated in the accompanying drawings.

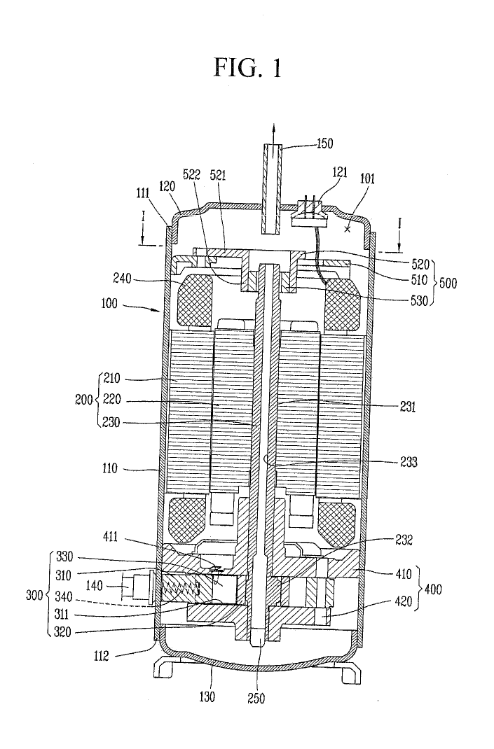

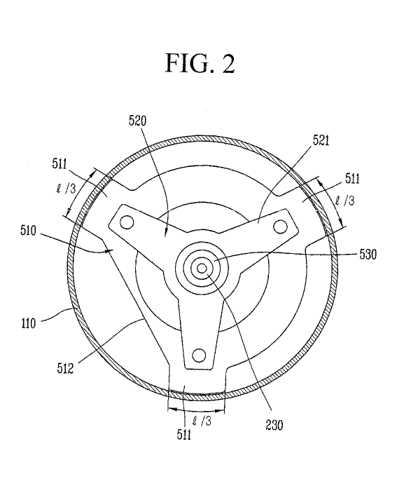

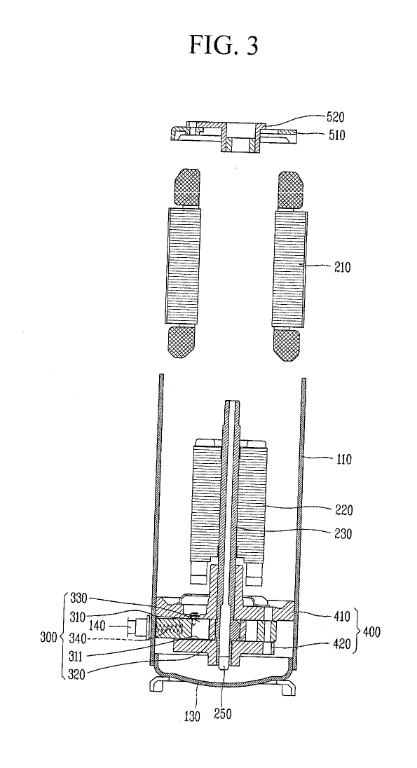

FIG. 1 is a longitudinal cross-sectional view illustrating an inner portion of a rotary compressor according to an embodiment. FIG. 2 is a cross-sectional view, taken along the line I-I of FIG. 1. FIG. 3 is an exploded cross-sectional view illustrating the compressor of FIG. 1.

As illustrated in FIGS. 1 and 2, in a rotary compressor according to an embodiment, a drive motor 200 that generates a driving force may be provided at an upper side of an inner space 101 of the hermetic container 100, a compression device or unit 300 that compresses refrigerant by power generated from the drive motor 200 may be provided at a lower side of the inner space 101 of the hermetic container 100, and a first bearing 400 and an second bearing 500 that support a crankshaft 230, which will be described later, may be provided at a lower side and an upper side of the drive motor 200, respectively.

The hermetic container 100 may include a container body 110, in which the drive motor 200 and the compression device 300 may be provided, an upper cap (hereinafter, “a first cap”) 120 that covers an upper opening end (hereinafter, “a first opening end”) 111 of the container body 110, and a lower cap (hereinafter, “a second cap”) 130 that covers a lower opening end (hereinafter, “a second opening end”) 112 of the container body 110.

The container body 110 may be formed in a cylindrical shape. A suction pipe 140 may penetrate and be joined with a circumferential surface of a lower portion of the container body 110. The suction pipe may be directly connected to a suction port (not shown) provided in a cylinder 310, which will be described herein below.

An edge of the first cap 120 may be bent and attached, for example, by welding, to the first opening end 111 of the container body 110. Further, a discharge pipe 150 that guides refrigerant discharged from the compression device 300 to an inner space 101 of the hermetic container 100 for or to a freezing cycle may penetrate a central portion of the first cap 120.

An edge of the second cap 130 may be attached, for example, by welding, to the second opening end 112 of the container body 110.

The drive motor 200 may include a stator 210 shrink fitted and fixed to an inner circumferential surface of the hermetic container 100, a rotor 220 rotatably arranged at an inner portion of the stator 210, and a crankshaft 230 shrink fitted to the rotor 220 that transfers a rotational force of the drive motor 200 to the compression device 300 while being rotated therewith.

The stator 210 may include a plurality of stator sheets laminated to a predetermined height, and a coil 240 wound on teeth provided at an inner circumferential surface thereof. The stator 210 may be shrink fitted and fixed to an inner portion of the hermetic container 100.

The rotor 220 may be arranged at an inner circumferential surface of the stator 210 with a predetermined air gap therebetween, and the crankshaft 230 may be inserted into a central portion thereof and joined by shrink fit to form an integral body.

The crankshaft 230 may include a shaft portion 231 joined with the rotor 220, and an eccentric portion 232 eccentrically formed at a lower end portion of the shaft portion 231 to be joined with a rolling piston, which will be described later. Further, an oil passage 233 may penetrate and be formed to extend in an axial direction at an inner portion of the crankshaft 230 to suck up oil of the hermetic container 100.

The compression device 300 may include the cylinder 310 provided within the hermetic container 100; a rolling piston 320 rotatably joined with an eccentric portion 232 of the crankshaft 230 that compresses refrigerant while being revolved in a compression space of the cylinder 310; a vein 330 movably joined with the cylinder 310 in a radial direction, such that a sealing surface at one side thereof may be brought into contact with an outer circumferential surface of the rolling piston 320 to partition a compression space (no reference numeral) of the cylinder 310 into a suction chamber and a discharge chamber; and a vein spring 340, which may be formed of a compression spring, that elastically supports a rear side of the vein 330.

The cylinder 310 may be formed in a ring shape. A suction port (not shown) connected to the suction pipe may be formed at a side of the cylinder 310. A vein slot 311, with which the vein 330 may be slidably combined, may be formed at a circumferential-direction side of the suction port, and a discharge guide groove (not shown) that communicates with a discharge port 411 provided in an upper bearing, which will be described later, may be formed at a circumferential-direction side of the vein slot 311.

The first bearing 400 may include an upper bearing 410 attached, for example, by welding, to the hermetic container 100 while covering an upper side of the cylinder 310 to support the crankshaft 230 in an axial and radial directions, and a lower bearing 420 attached, for example, by welding, to the hermetic container 100 while covering a lower side of the cylinder 310 to support the crankshaft 230 in axial and radial directions. The second bearing 500 may include a frame 510 shrink fitted to an inner circumferential surface of the hermetic container 100 at an upper side of the stator 210, and a housing 520 joined with the frame 510 rotatably with the crankshaft 230.

The frame 510 may be formed in a ring shape, and the frame 510 may include a plurality of fixed protrusions 511, for example, three, which may protrude a predetermined amount to adjoin or contact the container body 110, formed on a circumferential surface thereof. The fixed protrusions 511 may be formed to have a predetermined arc angle at an interval of approximately 120 degrees along a circumferential direction, and an end portion thereof may be bent to extend in parallel to an inner surface of the container body 110 to form a joining surface with the container body 110. A bearing bush 530 or ball bearing (not shown) may be combined with a bearing protrusion 522. Reference numeral 250 in the drawings is an oil feeder.

Further, as illustrated in FIG. 2, when a sum of widths of each of the fixed protrusions 511, i.e., lengths in a circumferential direction of the fixed protrusions 511 at a portion where the fixed protrusions 511 contact with an inner wall surface of the container body 110, is I, the compressor satisfies the following equation between I and an inner circumference L of the container body 110:

0.2≦I/L≦0.7 [Equation 1]

As described above, the stator 200 and the frame 510 may be fixed to an inner wall surface of the container body 110 by shrink fit. That is, a pressure may be applied to the frame 510 while the container body 110 expanded by heat is shrunk, and the frame 510 is deformed in proportion to the pressure. The deformation amount may be small, and thus, a width of the fixed protrusion 511 may be small. However, a cohesion between the frame 510 and the container body 110 may be weakened as the width thereof decreased. As a result, the I/L value should be controlled in an appropriate manner to obtain a sufficient cohesion strength while maintaining a preferable level of deformation amount.

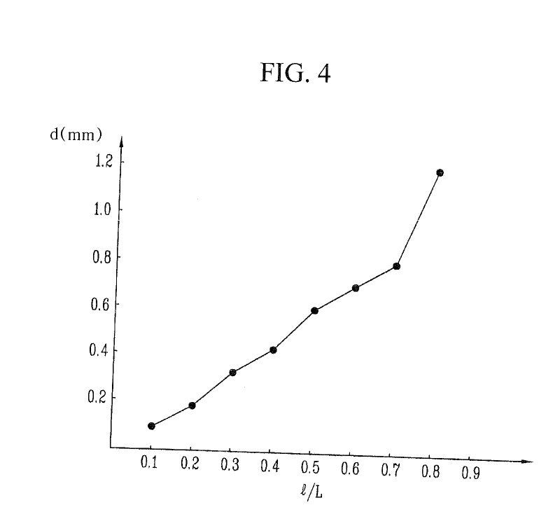

For this purpose, the inventors of the present application varied the I/L value to test a deformation amount and a cohesion strength based on the varied value. As a result, as illustrated in FIG. 4, it is seen that the deformation amount is drastically increased if the I/L value exceeds 0.7. If the deformation amount is excessively large, then it will have an effect on the durability of the frame and also cause a problem that the location of the frame may be deviated due to excessive residual stress subsequent to the completion of the assembly, and thus, it is required that the deformation amount should be maintained below a predetermined level. On the contrary, the cohesion strength increases as the I/L value increases, but the cohesion strength is too low in a case of less than 0.2. Accordingly, if the I/L value is equal to or greater than 0.2 and less than 0.7, then it may be possible to obtain sufficient strength while limiting the deformation amount within an intended level.

Further, when an outer diameter of the frame is D1, an outer diameter of the stator is D2, and an inner diameter of the container body is D3, the compressor may satisfy the following equation in a state prior to heating the hermetic container:

D1≧D2≧D3 [Equation 2]

In other words, an outer diameter of the frame may be set equal to or greater than that of the stator, and an inner diameter of the container body may be set to the least value.

In the case of D1=D2>D3, the frame and stator may receive a similar level of pressure from the hermetic container. As illustrated in the drawing, the stator 210 may have a larger contact area to the hermetic container compared to the frame, thereby having a larger clamping force. However, if the stator and frame are located close to each other, then the shrinking of the hermetic container may be prevented by the stator, and thus, the frame may not have a sufficient strength. On the other hand, if it is set to satisfy the equation D1>D2>D3, then a stronger pressure is applied to the frame, and due to this, the deviation of clamping force between the stator and frame may be resolved to some extent.

In the above-discussed embodiment, three fixed protrusions are arranged at an interval of approximately 120 degrees; however, embodiments are so limited, and the number and interval may be suitably changed according to circumstances.

Hereinafter, an assembly process of the above-discussed embodiment will be described.

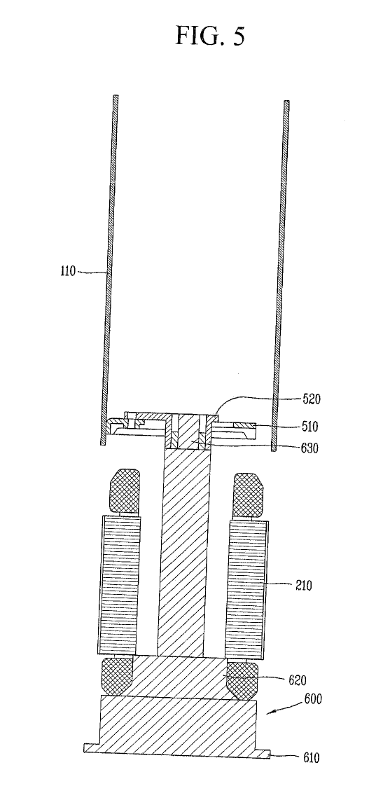

First, as illustrated in FIG. 5, a stator 210 and a second bearing 500 may be fixed to a fixing jig 600. The fixing jig 600 may include a container body support 610 at a bottom thereof, and a stator support 620 formed at a predetermined height up from the container body support 610. The height of the stator support 620 may be set similarly to a distance between a lower end of the container body 110 and the stator 210 in the finished product of the compressor.

Then, a frame support 630 may be located at an upper side of the stator support 620. A height of the frame support 630 may also be fixed, similarly to a distance between the stator 210 and frame 500 in the finished product, in such a manner that the frame 500 may be mounted thereon. Moreover, an outer diameter of the stator support 620 may be formed similarly to an inner diameter of the bearing bush 530 at an inner portion of the housing 520.

Accordingly, if the stator 210 and frame 500 are mounted on the fixing jig 600, then they both may be located at a concentric position with respect to each other. The fixing jig 600 may be manufactured from a metal material to allow the dimensions to be precisely managed, thereby allowing the location of the frame to be precisely disposed. Due to this, a relative location between the stator and frame may be precisely set.

In this configuration, the heated and expanded container body 100 may be covered over an outer portion of the stator 210 and frame 500. During the process of covering the container body 110 over the stator 210 and frame 500, the stator 210 and frame 500 are may be fixed to the fixing jig 600, and thus, the set position may be maintained. Then, pressure may be strongly applied to a surface of the frame 500 and stator 210 while the container body 110 is cooled and shrunk, thereby allowing them to be securely joined with each other due to the pressure. When the cooling of the container body 110 is completed, the fixing jig 600 may be removed and the container body 110 sealed with the crankshaft 230 mounted with the compression device 300 and the upper and lower caps 120, 130, thereby finishing the compressor.

Embodiments disclosed herein overcome disadvantages in the related art, and it is a technical task of the embodiments disclosed herein to provide a hermetic compressor having a structure capable of enhancing assembly precision as well as facilitating production.

In addition, embodiments disclosed herein provide a method of manufacturing a hermetic compressor capable of simplifying the manufacturing process and enhancing the assembly precision.

In order to accomplish the foregoing technical task, according to embodiments disclosed herein, there is provided a hermetic compressor, which may include a hermetic container; a stator fixed to an inner wall surface of the hermetic container; a rotor rotatably provided by the stator; a crankshaft combined with the rotor; a compression device or unit combined with the crankshaft to inhale or draw in and compress refrigerant; a bearing disposed to be separated from the compression device to support the crankshaft; and a bearing support or bearing support unit fixed to an inner wall surface of the hermetic container to support the bearing, wherein an outer diameter of the stator and an outer diameter of the bearing support are larger than an inner diameter of the hermetic container.

The stator and bearing support may be fixed to the hermetic container by shrink fit, and thus, the stator and bearing support may be stably fixed to an inner portion of the hermetic container by one fixation. In this manner, the stator and bearing support may be fixed through a single work, thereby enhancing concentricity with respect to the crankshaft compared to a case of individually fixing both. Moreover, it may exhibit very little thermal deformation compared to a work, such as welding or the like, thereby promoting the enhancement of quality.

An outer diameter of the bearing support may be equal to or larger than an outer diameter of the stator. Further, when a length of the hermetic container in an inner circumferential direction at a portion adjoining an inner wall of the hermetic container in the bearing support is I, and an inner circumference of the hermetic container is L, the compressor may satisfy the relation of or equation 0.2≦I/L≦0.7. A fixing force on the hermetic container may be insufficient in a case in which the I/L value is less than approximately 0.2, and a deformation amount of the bearing support due to the shrinking of the hermetic container during the shrink fit process may be excessively large in a case of exceeding approximately 0.7.

The bearing support may include a ring-shaped frame, to an inner side of which a bearing is fixed; and a plurality of fixed protrusions formed to protrude from an outer circumferential surface of the frame and brought into contact with an inner wall of the hermetic container. A number or location of the plurality of fixed protrusions may be set in an arbitrary manner. For example, three fixed protrusions may be disposed at an interval of approximately 120 degrees with respect to a center of the frame.

Further, embodiments disclosed herein provide a method of manufacturing a hermetic compressor. The method may include disposing a stator and a ring-shaped bearing support at a concentric position; heating a cylindrical hermetic container; and covering the heated hermetic container over an outer circumferential surface of the stator and ring-shaped bearing.

Fixation to the hermetic container may be made at one time in a state in which the stator and the bearing support may be disposed at a concentric position, thereby enhancing concentricity with respect to a center of the crankshaft, as well as simplifying the assembly process.

It may further include temporarily fixing the stator and ring-shaped bearing to a fixing jig. Through this, the location of the stator and bearing support may be constantly maintained even in the process of the hermetic container being covered or cooled and shrunk.

Further, when a length of the hermetic container in an inner circumferential direction at a portion adjoining an inner wall of the hermetic container in the ring-shaped bearing support is I and an inner circumference of the hermetic container is L, the compressor may satisfy the relation of 0.2≦I/L≦0.7. Moreover, when an outer diameter of the ring-shaped bearing support is D1, an outer diameter of the stator is D2, and an inner diameter of the hermetic container is D3, the compressor may satisfy the condition of or equation D1≧D2≧D3 in a state prior to heating the hermetic container. More particularly, in a case of D1≧D2, a pressure due to the hermetic container may be more strongly applied to the bearing support having a relatively short vertical length of the hermetic container compared to the stator, thereby more securely fixing the bearing support.

According to embodiments having the foregoing configuration, the stator and bearing support (and bearing) may be easily fixed to the hermetic container during the manufacturing process, as well as the concentricity of the stator and bearing support (and bearing) with respect to the crankshaft may be enhanced, thereby facilitating production as well as enhancing the quality of the product.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A hermetic compressor, comprising:
a hermetic container;
a stator fixed to an inner wall surface of the hermetic container;
a rotor rotatably provided adjacent the stator;
a crankshaft joined with the rotor;
a compression device joined with the crankshaft that draws in and compresses refrigerant;
a bearing disposed to be separated from the compression device that supports the crankshaft; and
a bearing support fixed to the inner wall surface of the hermetic container that supports the bearing, wherein an outer diameter of the stator and an outer diameter of the bearing support are larger than an inner diameter of the hermetic container.

2. The hermetic compressor of claim 1, wherein an outer diameter of the bearing support is equal to or larger than an outer diameter of the stator.

3. The hermetic compressor of claim 1, wherein when a sum of lengths of the bearing support in a circumferential direction contacting the inner wall surface of the hermetic container is I, and an inner circumference of the hermetic container is L, the compressor satisfies the following equation:
0.2≦I/L≦0.7.

4. The hermetic compressor of claim 3, wherein the bearing support comprises:
a ring-shaped frame, to an inner side of which a bearing is fixed; and
a plurality of fixed protrusions that protrudes from an outer circumferential surface of the frame and contacts with the inner wall surface of the hermetic container.

5. The hermetic compressor of claim 4, wherein three fixed protrusions are disposed at an interval of approximately 120 degrees with respect to a center of the frame.

6. A compressor, comprising:
a container;
a stator fixed to an inner wall of the container;
a rotor rotatably disposed adjacent the stator, the rotor having a crankshaft in communication with a compression device that draws in and compresses refrigerant;
a bearing that supports the crankshaft; and
a bearing support fixed to the inner wall of the container that supports the bearing, wherein an outer diameter of the stator and an outer diameter of the bearing support are larger than an inner diameter of the container.

7. The compressor of claim 6, wherein an outer diameter of the bearing support is equal to or larger than an outer diameter of the stator.

8. The compressor of claim 6, wherein the bearing support comprises:
a frame, to which a bearing is fixed; and
a plurality of fixed protrusions that protrudes from an outer circumferential surface of the frame and contacts with the inner wall of the container.

9. The compressor of claim 8, wherein the frame is ring-shaped.

10. The compressor of claim 9, wherein when a sum of lengths of the plurality of fixed protrusions in a circumferential direction contacting the inner wall of the container is I, and an inner circumference of the container is L, the compressor satisfies the following equation:
0.2≦I/L≦0.7.

11. The compressor of claim 8, wherein the plurality of fixed protrusions comprises three fixed protrusions disposed at an interval of approximately 120 degrees with respect to a center of the frame.

12. A method of manufacturing a compressor, the method comprising:
disposing a stator and a bearing support at a concentric position;
heating a cylindrical container; and
covering the heated container over an outer circumferential surface of the stator and bearing support.

13. The method of claim 12, wherein disposing the stator and the bearing support at the concentric position comprises temporarily fixing the stator and the bearing support to a fixing jig.

14. The method of claim 12, wherein when a sum of lengths of the bearing support in a circumferential direction contacting an inner wall of the container is I and an inner circumference of the container is L, the compressor satisfies the following equation:
0.2≦I/L≦0.7.

15. The method of claim 12, wherein when an outer diameter of the bearing support is D1, an outer diameter of the stator is D2, and an inner diameter of the container is D3, the compressor in a state prior to heating the container satisfies the following equation:
D1≧D2≧D3.

16. The method of claim 12, wherein the bearing support comprises:
a frame, to which a bearing is fixed; and
a plurality of fixed protrusions that protrudes from an outer circumferential surface of the frame and contacts with the inner wall of the container.

17. The method of claim 16, wherein the frame is ring-shaped.

18. The method of claim 16, wherein the plurality of fixed protrusions comprises three fixed protrusions disposed at an interval of approximately 120 degrees with respect to a center of the frame.

19. The method of claim 12, wherein the compressor comprises a hermetic compressor.

20. The method of claim 19, wherein the cylindrical container comprises a cylindrical hermetic container.
